(19) United States
(12) Patent Application Publication
(10) Pub. No.: US 2013/0262078 A1
(43) Pub. Date: Oct. 3, 2013

(54) SYSTEM AND METHOD FOR PROVIDING TEXT CONTENT ON WEB PAGES IN MULTIPLE HUMAN LANGUAGES

(71) Applicants: George GLEADALL, Boca Raton, FL (US); Ronnie Paskin, Ft. Lauderdale, FL (US); Shawn Stewart, Plantation, FL (US)

(72) Inventors: George GLEADALL, Boca Raton, FL (US); Ronnie Paskin, Ft. Lauderdale, FL (US); Shawn Stewart, Plantation, FL (US)

(21) Appl. No.: 13/436,633

(22) Filed: Mar. 30, 2012

(51) Int. Cl. G06F 17/28

(52) U.S. Cl. CPC G06F 17/28
USPC 704/3

(57) ABSTRACT

Embodiments described herein enable text content on web pages to be displayable in multiple human languages, without need to generate a new page or otherwise navigate the user away from the page under viewing.

### TECHNICAL FIELD

Embodiments pertain to a system and method for providing text content on web pages in multiple human languages.

### BACKGROUND

Sites that provide, for example, machine translations of text content are common. If a person wishes to determine a translation for text content on a web page, a user typically has to copy the text that is of interest, then submit the text to a language engine which then outputs a machine-generated translation. Often, the translations are imprecise, and not as good as human judgment.

### BRIEF DESCRIPTION OF THE DRAWINGS

FIG. 1 illustrates a system for displaying text content of web pages in multiple human languages, according to one or more embodiments.

FIG. 2 illustrates a method for providing a web page to include text content in multiple human languages, according to one or more embodiments.

FIG. 3 illustrates a method for providing alternative translations of text content to web pages, according to one or more embodiments.

FIG. 4 illustrates an example of a web page that includes text content with a translation into an alternative language, according to an embodiment.

FIG. 5 is a block diagram that illustrates a computer system upon which embodiments described herein may be implemented.

### DETAILED DESCRIPTION

Embodiments described herein enable text content on web pages to be displayable in multiple human languages, without need to generate a new page or otherwise navigate the user away from the page under viewing.

Additionally, embodiments described herein include a system or platform where translations for text content into alternative human languages is provided by a community of users.

Still further, some embodiments provide for translations, provided by way of input from users of the community, to be programmatically propagated to a collection of other web pages. In this way, community input is used to provide text content in a diverse range of alternative human languages.

Among other benefits, embodiments such as described herein enable a system that relies on human intelligence to translate text from a web page. The reliance on a community of users for purpose of receiving translations results in a robust and effective mechanism for providing text translation, particularly amongst a diverse number of alternative human languages.

Furthermore, some embodiments enable web content to incorporate embedded or otherwise hidden text translations that can be made visible in response to user selection or other events. As such, the translations for the web page can be provided without navigating the user away from the page that is being viewed.

According to embodiments, text translations can be embedded statically (when the page is served) or dynamically (e.g., through the addition of elements or nodes to the underlying data structure).

According to an embodiment, a web page is provided with functionality that includes an interface for an editor class user. A translation input is recorded from the editor class user, to translate an original text item provided on the web page from a first human language to a second human language. The web page can then be configured to include a translated text item that is in the second human language. The web page can subsequently be downloaded by one or more other users, with the translated text item being provided to supplement or replace the original text item based on an event or user input.

In another embodiment, one or more text items are identified that comprise a portion of a web page. The one or more text items may be provided in a first human language. A translation of the one or more text items into a second human language can be obtained. At least a portion of the web page is provided to be modal, so that it can be displayed in each of (i) a first mode in which the one or more text items is displayed in the first human language and not in the second human language, and (ii) a second mode in which the one or more text items is displayed in the second human language.

Still further, embodiments include a system for providing content in multiple human languages. The system includes a memory that stores a set of instructions, and one or more processors that use instructions in the set of instructions to provide a presentation component for providing a web page. According to an embodiment, the presentation component provides a web page to include a text content item that is provided in a first human language and in a second human language. The presentation component provides the web page in (i) a first mode in which the text content item is viewable in the first human language and hidden in the second human language, and (ii) a second mode in which the text content item is viewable in the second human language and hidden in the first human language.

As used herein, a “text item” can correspond to one or more terms, words, phrases, sentences, paragraphs or combinations thereof.

One or more embodiments described herein provide that methods, techniques and actions performed by a computing device are performed programmatically, or as a computer-implemented method. Programmatically, as used herein, means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be stored on a computer-readable medium. Machines shown or described with figures below provide examples of processing resources and computer-readable mediums on which instructions for implementing embodiments of the invention can be stored and/or executed. In particular, the numerous machines shown with embodiments described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets), and magnetic memory. Computers, terminals, network enabled devices (e.g., mobile devices such as cell phones) and tablets are all examples of machines and devices that utilize processors, memory, and instructions stored on computer-readable mediums. Additionally, embodiments may be implemented in the form of computer-programs, or a computer usable medium capable of storing instructions for such a program.

System Description

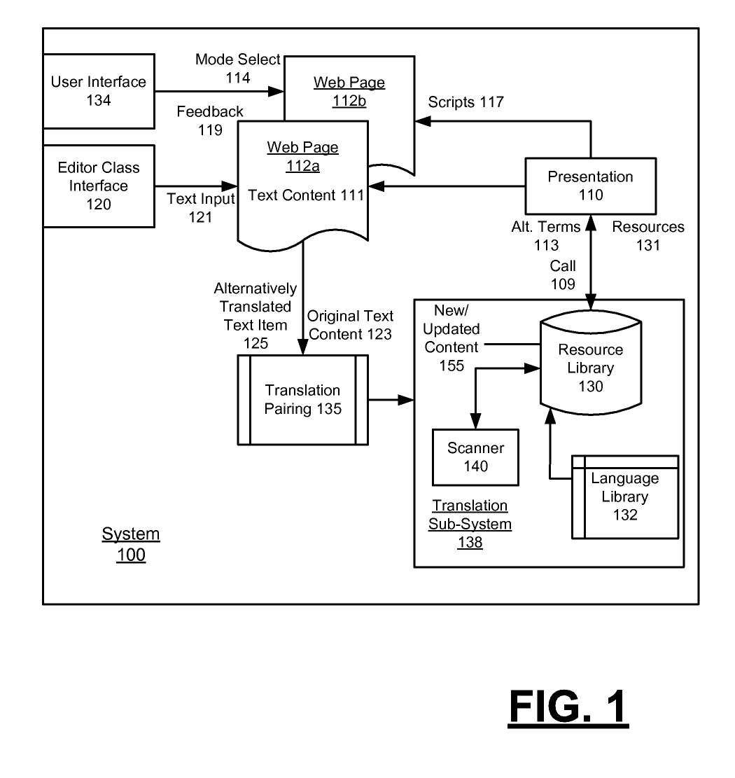

FIG. 1 illustrates a system for displaying text content of web pages in multiple human languages, according to one or more embodiments. According to embodiments, system 100 enables the generation of web pages which carry alternative human language translations for words, terms or phrases, as provided by input from some users of the web page. Furthermore, some embodiments enable individual web pages to be provided in multi-modal form, so that the individual web pages can be viewed in alternative modes that coincide with different human language settings.

In some embodiments, when web pages are provided in mufti-modal form, alternative language variants to some or all of the text content provided with the web content are displayed when a mode selection is manually or programmatically signaled. Thus, web pages can be mufti-modal with respect to human language settings, and further can be alternated or toggled between different modes to display different human language translations of select text content, without need to open or generate a new web page.

In an embodiment, system 100 includes a presentation component 110 that provides multiple web pages 112a (representing web page that can receive translation input or edit), 112b (representing web page that can be rendered with multiple available human language translations) at one or more sites of a network domain. The web pages 112a, 112b can be generated from resources 131 of a resource library 130. The content of the individual web pages 112a, 112b can include text items 111, as well as other content such as images, video and/or audio. According to one or more embodiments, some or all of the text items 111 for the web page 112a, 112b can be provided in an original human language (e.g., English) as well as one or more translated human languages. The text items 111 can include, for example, a headline or title, sub-titles, captions, user-generated comments, and text body content. Thus, portions of the web pages 112a, 112b corresponding to, for example, a headline, title or caption can be made available in one or more alternative human languages.

In operation, at least some components of system 100 can be implemented as network side resources (e.g., on a server), while select components can be operated on an end-user machine. For example, with reference to components of FIG. 1, functionality provided through or with the web page 112a, 112b can be provided on the end user machine, such as in the way of scripts that run on the end user's browser, or functionality provided through installation and operation of a client application. In one implementation, system 100 includes a service, operable to communicate with client terminals (e.g., terminals that operate web browsers) in order to provide text content in multiple human languages. Accordingly, implementation of system 100 can include use of one or more servers, or other network-side computing environments such as provided by peer-to-peer networks, etc. In alternative implementations, some or all of the components of system 100 can be implemented on end user machines, such as through applications that operate on user terminals. For example, a client application may execute to perform the processes described by the various components of system 100.

According to some embodiments, the web page 112b (representing web pages that are viewed) can be provided in modal form, with each mode of the web page corresponding to a particular human language setting. For example, the web page 112b may be rendered to include a first mode for English (e.g., all text content displayed in English), and a second mode for an alternative language such as Spanish (e.g., some or all text content in Spanish). In variations, the web pages 112b may be rendered to include third, fourth or additional modes for other languages. In other variations still, an alternative mode for the web page 112b can render text content in multiple foreign languages. For example, a foreign language mode of a web page 112b can display a single text item in multiple foreign languages, or display various text items in different languages (e.g., a first item in Spanish, and a second item in French). The modal configuration of the web page 112b enables a user to select 114 to view the web page 112b in alternative modes, so that the user can view some or all of the text content in alternative languages without having to open a new web page or otherwise navigate away from the web page being viewed.

In embodiments, the web page 112a can include programmatic components that provide an editor interface 120 for receiving input that identifies alternative human language translations for select terms that are provided in the web page. For example, the web page 112a can include scripts that execute within the browser component of the end user machine to enable some users to perform operations such as (i) log-in or register, (ii) select original text that it to be translated, (iii) enter translated text for selected text, and (iv) cause the entered translation to be saved as part of the web page 112a. In some embodiments, the translation provided from a particular user can be propagated to other web pages or resources which carry the same original text.

In some embodiments, only some users of the web page 112a (representing a page under edit) can provide translation inputs (e.g., editor class users). More specifically, in some embodiments, the editor interface 120 is restricted to individuals who have permission to modify or specify human language translations for text content appearing on web pages provided through system 100. In some embodiments, system 100 identifies a class of users that are editors (“editor class users”), and these individuals are provided permission to provide human language translations via the editor interface 120. For example, the editor class user may be able to provide a user name and password that triggers additional functionality corresponding to the editor interface 120. Editor class users can correspond to, for example, persons whom (i) have applied to be an editor class user, with represented or known ability to translate in specific language, (ii) are registered users of the site, and/or (iii) whom have accepted a term or service agreement.

In variations, system 100 provides all users with editor permissions for purpose of entering alternative human language translations via the editor interface 120. Still further, variations provide for all users to be provided editor abilities, unless their abilities have been revoked.

The web page 112a can be provided in a variety of formats or languages (e.g., HTML or HTML5). In some embodiments, the web page 112a includes multiple elements that include semantic markup (e.g., HTML5) to denote the language for a corresponding block. That markup may be used to filter and toggle the elements that are displayed, to coincide with a language (or mode) that is selected. In this way, two or more languages may be embedded in the web page 112a, either statically (e.g., when the page is served) or dynamically when the page is served.

In an embodiment, editor interface 120 enables an editor to enter text input 121 through the web page 112a. The text input 121 can be associated with original text content 123 provided on the web page 112a. In one implementation, text input 121 is associated with the original text content 123 and stored in the resource library 130. Additionally, the text input 121 can be provided with a classification that identifies a language of the text input. For example, the original text content 123 can correspond to a term or phrase on a web page provided in English (original human language), and the text input 121 can provide a translation of the term in an alternative language (e.g., French). In the example, the text input 121 can be provided with a French classification, which also associates the text input 121 with a French mode for the web page 112a.

In some embodiments, the text input 121 provided through the editor interface 120 is received and embedded with resources that provide the web page 112a. In particular, the text input 121 can result in a translation pairing 135 that identifies (i) an alternatively translated text item 125 that corresponds to, or is determined from, the text input 121 (e.g., a translated phrase), and (ii) the original text content 123. A given editor class user can provide multiple sets of translation pairing 135, corresponding to different terms, phrases or sentences of the web page 112a. The web page 112a can include functionality to record the sets of translation pairing 135 provided from individual editor class users. The set of alternative language terms 135 provided from the given user can be communicated to a centralized location, such as with resource library 130, where the terms become part of the page in future renderings. In this way, the set of translation pairings 135 can be associated with the web page 112a in the resource library 130. Furthermore, one or more embodiments provide for the web page 112a to receive input from multiple editor class users who provide different translations for the terms that appear on the page. As described below, when the web page 112a is subsequently downloaded by another user, the alternatively translated text item 125 can be embedded or otherwise made available for display in different modes of the web page 112a. For example, the document object model (DOM) of the web page 112a can be modified to include the alternatively translated text item. Functionality, such as for providing display states for the original text item 123 and/or alternatively translated text item 125 can also be integrated or otherwise included with the DOM of the web page 112a.

As an alternative or addition, the system 100 includes a translation sub-system 138 which includes programmatic resources for enabling web pages to include translations of text content. In an embodiment, the translation sub-system 138 includes a text item scanner 140 that propagates the set of translation pairings 135 received for one web page 112a to other web pages 112b. In particular, scanner 140 operates to identify other existing web pages 112b which utilize the original text content 123 of a given translation pairing 135. When such text content is identified, the scanner 140 can cause the alternative translation 125 for the original text content 123 to be embedded or otherwise included with one or more other web pages 112b. In an embodiment, the scanner 140 accesses the resource library 130 to identify the other web pages 112b which utilize, for example, the same original text content 123 of a given translation pairing 135 received from the web page 112a that was edited. In this manner, the alternatively translated term 125 of the translation pairing 135 can be automatically and programmatically embedded or associated with other web pages that include the original text item 123 as part of their respective content.

In one embodiment, the scanner 140 operates to identify instances in which an original text item 123 appears in the resources library 130. For example, the scanner 140 can scan the text content used to generate different web pages 112a, 112b provided at a website or domain to identify the original text content 123 (e.g., “Batting Average”) that received the translation input. When found, the scanner 140 (or other programmatic resources, such as provided with the library 130) embeds or otherwise associates the alternatively translated text item 125 (e.g., “promedio de bateo”) with the original text content 123 as provided on the identified web page. As such, the alternatively translated text item 125 can replace the original text item 123 on newly found web pages in a manner that maintains the original formatting, size, positioning and features of how the original text item 123 was presented.

In variations, still, programmatic resources such as provided through the scanner 140 can include intelligence that links the original text item 123 to other words or phrases in the same language. The programmatic resources can then associate the alternatively translated text item 125 with alternative items in the original language which are deemed, for example, to be analogous or synonymous to the original text item 123. The scanner 140 can then associate the alternatively translated text item 125 with terms in the content of resources in library 130 that are synonymous or analogous to the original text item 123. For example, if the original text item 123 is an acronym, programmatic resources may associate the alternatively translated term with both the acronym and its variants, such as the term for the acronym in expanded form.

As an alternative or addition to propagating translation to existing pages, some embodiments provide for automatically updating new web pages, or newly updated web pages, to include translations that are embedded or otherwise provided with the page. According to one or more embodiments, the resource library 130 includes, for example, web pages 112a, 112b, content for web pages, and/or a translation library 132. The translation library 132 can store translation pairings 135, so as to provide a matrix (or list) of text items (e.g., words, phrases) in an original language and one or more alternative translated human languages. The resource library 130 can be provided for presentation component 110 to display web pages with alternative human language listings of the page's text content. The text content of newly created or updated web pages can be referenced against the translation library 132 to identify text items that have translations available.

As described with FIG. 1 and other embodiments, the translations provided from users (e.g., editor class users) can become an online community effort that utilizes human intelligence, rather than machine translation. According to some embodiments, system 100 may include functionality to enable users that provide translations to receive feedback from the community, such as in the form of ratings that rate the individual performance of a particular editor. For example, viewers of the web pages 112b can select to view alternative translations, and provide feedback 119 about the user's perception of the quality of the translation. In this way, editor class users can be rated, or otherwise judged amongst the community for their performance. According to some embodiments, provisions may be put in place to reduce or eliminate poor translation editors, while promoting others with a rating or feedback.

Modal Display of Web Pages with Alternative Human Language Translations

The presentation component 110 provides web pages 112b with elements and/or functionality that enables the individual web pages 112b to be viewed with select text presented in alternative human languages. In some embodiments, the web pages 112b are provided with elements and/or functionality that enables the individual pages to be modal, so that the individual web page 112b can be toggled between modes that correspond to alternative human language. In each mode, select terms of that page's text content are rendered in a corresponding human language. Moreover, embodiments provide that non-selected language variants of a text item are hidden relative to terms of the selected human language(s). Thus, for example, the user can toggle web page 112b from English to non-English. In the mode of English, non-English translations for English terms are hidden. In the mode of non-English, non-English translations (e.g., terms in Spanish, French, etc.) are made visible, and original text content coinciding with the translated terms are hidden. In a similar example, the user can toggle the web page 112b from English to Spanish, in which case select English terms are transitioned from visible to hidden in favor of transitioning Spanish translations from hidden to visible. In contrast to many conventional approaches, the web pages 112b can be operated to display the alternative human languages without need for generating or loading a new translation page.

In some embodiments, web pages 112b are provided (e.g., in the resource library 130) with alternatively translated terms being embedded in the underlying code of the web page. In one implementation, the individual web pages 112b are displayed with input corresponding to alternative translated text items 125, as provided through, for example, the editor interface 120.

In other implementations, the scanner 140 can operate to embed alternative translations of select terms that receive translation inputs from an editor-level interaction at another web page. For example, an editor class user can provide a translation of a first term when viewing a first page, and the scanner 140 can embed the provided translation on other pages that include the same term that received the translation. In this way, the scanner 140 can propagate translations through numerous web pages 112b that are hosted by, for example, a network domain that utilizes the system 100.

The presentation component 110 can present the individual pages 112b in a manner that enables the pages 112b to be modal, so as to toggle between or switch modes in response to a user input or designated event. In one embodiment, the web page 112b includes scripts 117 or other functionality that hide or replace text items. The scripts 117 can be linked to a mode setting for the individual page. The web pages 112b can be presented with a user-interface feature 134 or functionality that enables the viewer of the web page to select or toggle between modes. Thus, the user is able to make mode selection through the user interface feature 134 (or functionality). When user input specifies a mode 114, the scripts 117 can run to (i) identify those text items in the web page which have alternative translated text items 125 (corresponding to the language of the selected mode), (ii) hide the selected terms, and (iii) make visible the alternative human language translations that correspond to the set of terms that were hidden. For example, a user can download webpage 112b through the user's browser, then select an alternative mode (e.g., alternative to a mode for default human language) for the web page 112b. In response to the user selection, the web page 112b toggles its display of select terms from the original or default human language to the alternative human language corresponding to the selected mode. In this way, the individual pages 112b can be provided with embedded translations, and the web page 112b can be switched or toggled between states to view one or more alternative human language translations for select terms.

As an alternative or variation, presentation component 110 displays web pages with alternative translations by dynamically substituting original text content 123 with alternatively translated text items 125 as provided from, for example, the translation library 132. For example, in some embodiments, a corresponding node can be added to the DOM of the web page 112a. For example, the set of terms of the web page 112b which have alternative human language translations available in the translation library 132 can be marked. When a modal event occurs (e.g., user selecting to view a web page in an alternative human language), one embodiment provides for the presentation component 110 to make a call 109 for an alternative set of terms 113 that are translations to some or all of the text content items (e.g., words or phrases) provided with the page 112b. The presentation component 110 can then replace the set of marked terms with the alternative set of terms 113.

The manner in which presentation component 110 displays alternative human language translations can be varied, depending on implementation and design for system 100 or its components. For example, as described with some embodiments, the presentation component 110 can include functionality (e.g., with web page 112b) that provides for alternative translations of text content to be hidden. When user selection is made to see the alternative translations, the functionality provided by or with the presentation component makes the translations visible in place of the terms that are being translated (i.e., the term being translated becomes hidden). In variations, however, the alternative translations for selected text items of a given webpage 112b can be displayed in alternative forms, such as by way of an overlay (e.g., text content appearing over other content, fly-over, etc.), or side-by-side placement with the term that was translated.

As described, some embodiments described above provide for presentation component 110 to enable individual web pages 112b to be modal, in that the individual web pages 112b can be rendered as a whole in alternative modes. In each mode, some or all of the text items on the web page 112b have a certain human language classification (e.g., classification corresponding to a particular language, classification for “non-English”). As an alternative or variation, however, some embodiments provide for the presentation component 110 to generate scripts 117 or other functionality to enable segments of a given webpage 112b to be modal, separate from other text content or portions of the web page. For example, the web page 112b can be configured so that a user can select text content on the webpage, and have alternative human language translations for some or all of the text appearing in the selected content made visible or otherwise displayed. Thus, the entire page is not modal, but selected portions of the text content in the page can be alternatively displayed, without affecting the rendering of other text content on the page which can also have available translations. The alternative display of the text content can be performed without opening a new web page. In such an embodiment, alternative translations to select text items can be embedded on webpage and then rendered as, for example, replacement of select text items (so that a replaced item is made hidden, while the translated item is made visible), as an overlay (so that the translated text items appear next to a selected text content), or side-by-side with existing text content.

Still further, some embodiments provide for presentation component 110 to display words or terms that have available translations in an indicative format (e.g., colored and hyperlinked), so that the words or terms are selectable, apart from other text content appearing on the page. When these words or terms are selected, their alternative human language translations are displayed in place of, adjacent to or over (e.g., as a flyover) the selected words.

Methodology

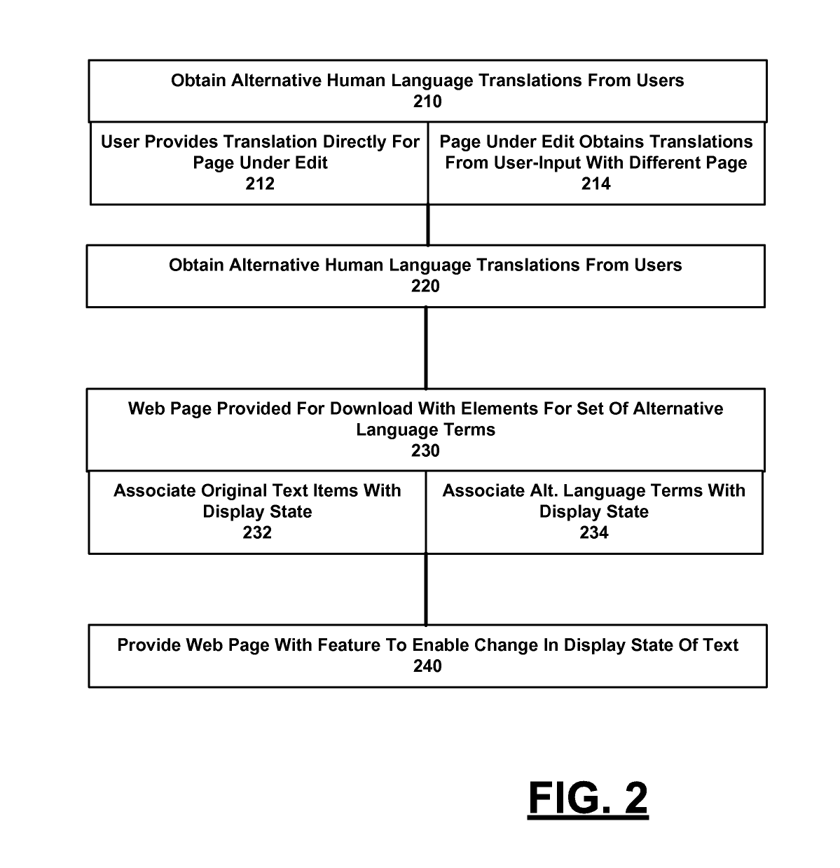

FIG. 2 illustrates a method for providing a web page to include text content in multiple human languages, according to one or more embodiments. A method such as described by an embodiment of FIG. 2 may be implemented using a system such as described with an embodiment of FIG. 1. Accordingly, reference may be made to elements of system 100 for purpose of illustrating a suitable component for performing a step or sub-step being described.

In one embodiment, alternative human language translations are obtained from users of a website or network domain (210). For example, a user may download a particular web page 112a, view the contents, and identify select text terms that the user can translate. In some embodiments, the user can select to edit the web page 112a that is being viewed with the submission of translations (212). For example, in one implementation, the user can select the term the user wants to edit (e.g., user highlights the term). In response to the user selection, the web page 112a can display an interface that enables the user to specify an alternative term. The alternative term can correspond to a translation of the same term (e.g., alternatively translated text input 125). In some embodiments, the users that have ability to specify the translations is an editor class user. Editor class users can be provided with the ability to perform functions, such as specify alternative translations, which other users may not have.

In variations, the language translations can be programmatically obtained for a web page under edit, but from users who provide the translation edits for another web page other than the one being altered (214). For example, translation edits entered directly for the web page 112a can be identified for use with one of the web pages 112b. In this way, system 100 can be adapted to propagate the changes made through the edited web page to the other existing web pages. In one implementation, an editor class user can interact with a particular web page 112a to provide a translation for some text items that appear on the page. The scanner component 140 can then scan the resource library 130 for other existing pages (or content items) that have a same or equivalent text item to that which received a translation from the editor class user.

In variations, the language library 132, for example, can maintain translation pairings 135, corresponding to translations that users provide for text items of web page 112a that received direct translation edits. Subsequent to translation pairings 135 being created, text content from newly created or updated content 155 can be scanned for text items that appear in the translation pairings 135 that are received for another page. For example, when a new web page is created, or an existing page is updated with additional text item (e.g., news page can be updated with new stories), the text content can be scanned for text items that have received translation edits when presented on other pages. Based on the translation library 132 (or stored sets of translation pairings 135), the presentation component 110 and/or resource of the translation sub-system 138 can scan newly created or updated content 155 for text items that have corresponding translations.

For given pages that are to be displayed with alternative translations, some embodiments provide for the obtained translations to be saved (220) and made part of the page's underlying elements. According to some embodiments, the users can specify alternative translations (e.g., alternatively translated text input 125) via the editor interface 120. The terms that receive translations can be coded and associated with the alternative translations.

In an embodiment, the web page 112a can include functionality that links a set of alternative language terms that includes the original text item and any translations the particular term has received by one or more editor class users. A given editor class user can create multiple sets of alternative language terms by identifying multiple terms on the page that need translations. Additionally, the web page 112a can include translations specified by other edit-users. Furthermore, one set of alternative language terms can include a first alternative translation provided from a first editor user, and a second alternative translation provided from a second editor user. Thus, an originally provided term or phrase can be provided with multiple alternative translations, each of which are for different languages.

Still further, some editor users may translate a given term differently. Thus, a set of alternative language terms can include multiple translations of an original term that are in a same alternative human language.

When the particular web page 112b is downloaded by a given user, the web page is downloaded with its original text content, as well as with elements that correspond to a set of alternative language terms 125 that have been provided from a community of users (e.g., editor class users) (230). Thus, for example, the web page 112a can be downloaded with elements that link original text items (e.g., words, phrases, sentences) with alternative translations provided by one or more editor class users.

In providing the web page 112b with the elements, the page can be provided with functionality that (i) associates original text items of the page 112b with a modal display state (232), and terms of the set of alternative language terms with an opposite or reverse modal display state (234). For original text items, the modal display state can include, for example, a default state of visible, and a toggled state of hidden. For the set of alternative language terms, the modal display state can include, for example, a default state of hidden, and a toggled state of visible.

The web page 112b can be provided with functionality that includes one or more features that are selectable to trigger a change in the display state of the visible and hidden text content (240). Depending on implementation, the terms in the set of alternative language terms can be switched from one display state to another either individually, in groups, or in their entirety, in response to mode selection input from the user (e.g., viewer of the web page).

In an embodiment, the functionality for switching the display state of the original text items/alternative language terms can be provided as a user interface feature. When selected, scripts or other functionality provided with the web page after the display states of the text content. For example, the user can load the web page into a browser, then select an icon or other user-interface feature in order to change the language mode of the web page. When the language mode of the page is changed, functionality embedded with the web page changes the state of at some terms in the set of alternative language terms. In particular, the term in the set that were visible prior to the mode selection can be made hidden, and the term that is of the human language that coincides to the mode selection can be made visible.

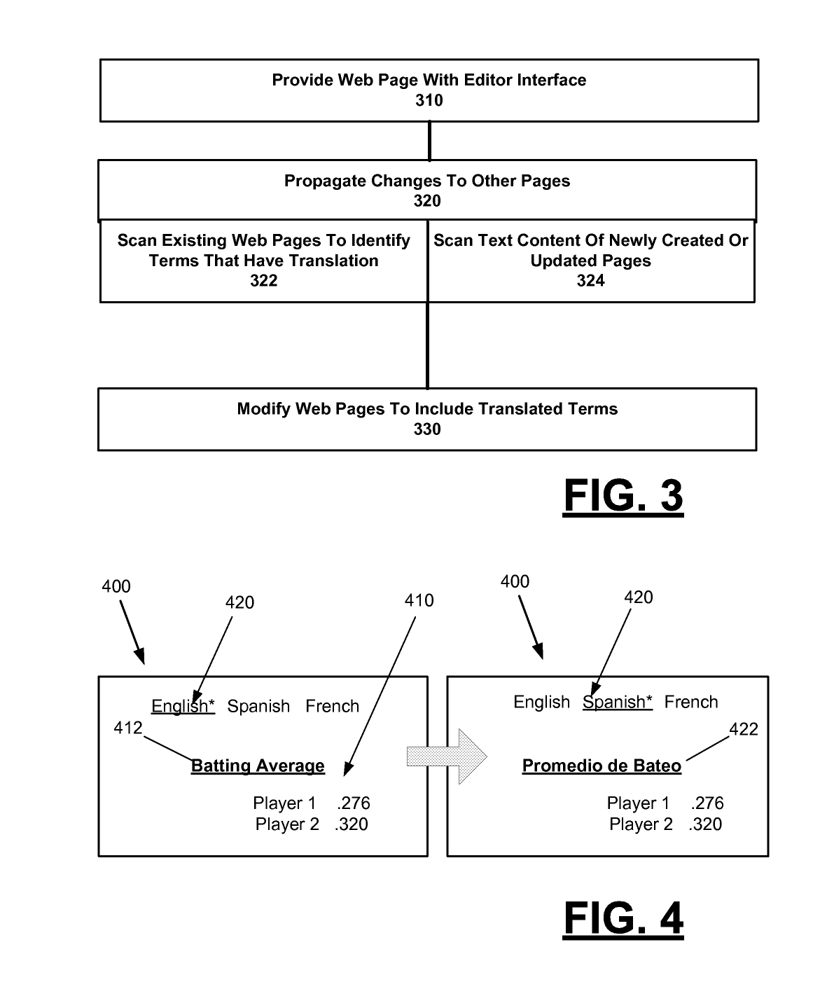

FIG. 3 illustrates a method for providing alternative translations of text content to web pages, according to one or more embodiments. A method such as described by an embodiment of FIG. 3 may be implemented using a system such as described with an embodiment of FIG. 1. Accordingly, reference may be made to elements of system 100 for purpose of illustrating a suitable component for performing a step or sub-step being described.

A given web page 112a can be provided with an editor interface to enable users (e.g., editor class of users) to provide translation inputs for the web page (310). The web page 112a can be provided from a website, domain, or network property, so that its content and resources are shared with a collection of other web pages.

According to some embodiments, when a language translation is obtained on a given web page 112a, one or more components of system 100 operate to propagate the translation to other web pages that are hosted by a website or domain that utilizes the system 100 (320). For existing web pages, the resources (e.g., page contents) of library 130 are scanned to identify pages that include the term that received the translation (322). For newly created or updated web pages, the text content can be scanned to identify presence of terms that have been provided translations (324).

In one embodiment, each web page 112b or resource that contains the term is modified so as to embed the translated terms (330). Optionally, the original text items that have available translations can be marked visually, so as to communicate to the user that the term, set of terms or page can be selected for alternative language translations. The visual marking can correspond to, for example, hyper-linking the term, changing the formatting of the term relative to other text content that does not include translations, etc. In some implementations, the document object model (DOM) of the web page 112a is modified to include the alternative language terms, along with the programmatic code that can set the display states of the original text items and the alternative language terms (e.g., default states of visible and hidden, respectively, and corresponding toggled states of hidden and visible).

In alternative implementations, scripts can be included with the web pages to implement call functions in response to, for example, user input. The call functions can, for example, identify the alternative language terms for the marked original text and enable the substitution of the original text item for the translated term on-the-fly, and in response to user input.

In implementation, embodiments provide for the web pages 112b can be subsequently rendered with the term that received the translation being visible, and the translated term being hidden. A user can provide a mode selection input for the page, set of terms or individual term. In response to the mode selection input, the translated terms can be made visible from hidden, while the original term can be switched from visible to hidden.

FIG. 4 illustrates an example of a web page that includes text content with a translation into an alternative language, under an embodiment. In an embodiment, a resource or portion of web page 400 include text content 410, including original text items 412 corresponding to terms or phrases. A select original text item 412 (“Batting Average”) is provided one or more translations 422 in different human languages. The page can include various other text content, such as news stories, photograph captions, abbreviations, etc. A portion of the text content (e.g., sentence or term) can be provided in alternative human languages, based on input from the community of users. For example, some terms can be expressed in multiple languages (e.g., English, Spanish, French), while other terms can be expressed in only one alternative language.

In the example provided, a feature 420 is provided to enable modal selection of how text content is to be presented. The feature 420 can trigger functionality that causes select text content to be replaced with alternative language terms. In the example provided, three modes are provided: English (default), Spanish, and French. More or fewer foreign languages may be provided for, depending on implementation. The user can provide input through feature 420 to select a mode. In an embodiment, the mode selection is applicable to the entire page. Thus, for example, if the user selects Spanish mode, select words or phrases that have Spanish equivalents available (e.g., embedded translations) are made visible, and the coinciding original text items are made hidden. Likewise, if the user selects French mode, select words or phrases that have French equivalents available are made visible, and coinciding Spanish or English text is made hidden.

In alternative variations, the mode selection can be specific to a portion of a page, or to specific text items (e.g., the term “Batting Average”). Thus, the user may select one portion of the page for translation (e.g., into Spanish), while, for example, maintaining the default status of the other portion of the page (e.g., English). While an example of FIG. 4 shows modes that coincide with specific languages, in variations, a mode may coincide with multiple languages (e.g., class of languages). For example, a “non-English” mode may be selectable using a feature 420.

Computer System

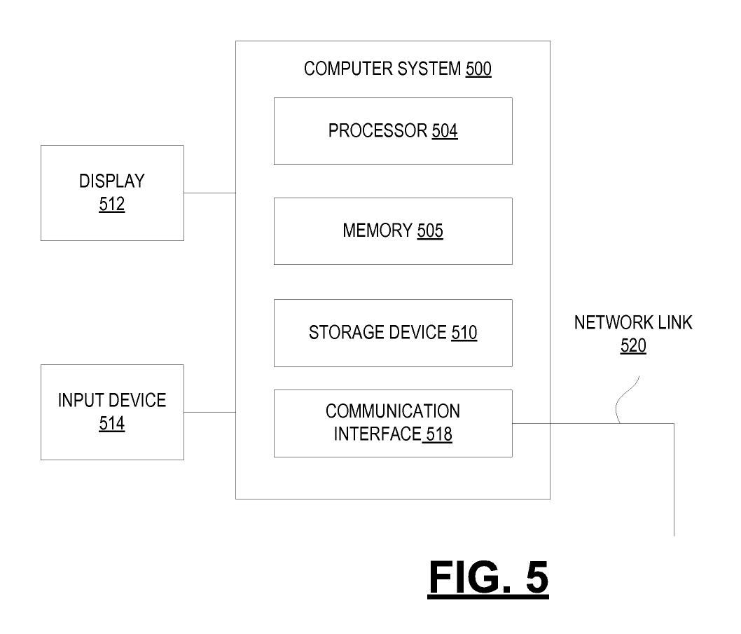

FIG. 5 is a block diagram that illustrates a computer system upon which embodiments described herein may be implemented. For example, in the context of FIG. 1, system 100 may be implemented using a computer system such as described by FIG. 5.

In an embodiment, computer system 500 includes processor 504, memory 506 (including non-transitory memory), storage device 510, and communication interface 518. Computer system 500 includes at least one processor 504 for processing information. Computer system 500 also includes a main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. A storage device 510, such as a magnetic disk or optical disk, is provided for storing information and instructions. The communication interface 518 may enable the computer system 500 to communicate with one or more networks through use of the network link 520 (wireless or wireline).

Computer system 500 can include display 512, such as a cathode ray tube (CRT), a LCD monitor, and a television set, for displaying information to a user. An input device 514, including alphanumeric and other keys, is coupled to computer system 500 for communicating information and command selections to processor 504. Other non-limiting, illustrative examples of input device 514 include a mouse, a trackball, or cursor direction keys for communicating direction information and command selections to processor 504 and for controlling cursor movement on display 512. While only one input device 514 is depicted in FIG. 5, embodiments may include any number of input devices 514 coupled to computer system 500.

Embodiments described herein are related to the use of computer system 500 for implementing the techniques described herein (such as described with FIG. 2 and FIG. 3). According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for providing content in multiple human languages, the method being implemented by one or more processors and comprising:
(a) identifying one or more text items that comprise a portion of a web page, the one or more text items being in a first human language;
(b) obtaining a translation of the one or more text items into a second human language;
(c) providing at least a portion of the web page to be modal in how it can be displayed, so that the portion of the web page can be selected to be displayed in each of (i) a first mode in which the one or more text items is displayed in the first human language and not in the second human language, and (ii) a second mode in which the one or more text items is displayed in the second human language.

2. The method of claim 1, wherein (c) includes embedding the translation of the one or more text items in the web page.

3. The method of claim 2, wherein in the first mode, the one or more text items are hidden in the second human language, and in the second mode, the one or more text items are hidden in the first human language.

4. The method of claim 1, wherein (b) includes storing the translation of the one or more text items in a data store, and wherein (c) includes (i) retrieving the translation of the one or more text items from the data store, and (ii) replacing the one or more text items with the translation.

5. The method of claim 1, wherein (c) includes enabling a user to toggle between the first mode and the second mode without reloading the web page.

6. The method of claim 1, wherein (b) includes obtaining the translation for the one or more text items from an editor class user.

7. The method of claim 6, further comprising enabling the editor class user to interact with the web page in order to provide input corresponding to the translation of the one or more text items.

8. The method of claim 7, wherein the one or more text items correspond to a term or phrase, and wherein the method further comprises:
associating the translation of the term or phrase with the term or phrase;
identifying use of the term or phrase with one or more other web pages;
providing the one or more other web pages with the translation for the term or phrase.

9. The method of claim 8, further comprising providing the one or more other web pages to be displayable in at least one alternative mode in which the term or phrase appears in the second human language.

10. The method of claim 6, wherein (b) includes obtaining the translation for the one or more text items from a library of translations for terms or phrases between the first human language and the second human language.

11. The method of claim 10, further comprising enabling an editor class user to provide at least some of the translations that comprise the library of translations.

12. The method of claim 6, further comprising:
identifying the editor class user to viewers of the web page in the second mode, and
enabling other users of the web page in the second mode to provide feedback rate the editor class user or the translation provided by the editor class user.

13. A method for providing content in multiple human languages, the method being implemented by one or more processors and comprising:
(a) providing a web page with functionality to provide an interface for an editor class user;
(b) recording a translation input the editor class user makes to translate an original text item provided on the web page from a first human language to a second human language; and
(c) enabling the web page to be subsequently downloaded by one or more other users, with a translated text item that is in the second human language being included with the web page to supplement or replace the original text item, the translated text item being based on the translation input.

14. The method of claim 13, further comprising enabling a user to select to replace the original text item with the translated text item.

15. The method of claim 13, wherein (c) includes enabling the web page to be modal when downloaded, wherein in a first mode, the web page displays the original text item in the first human language, and wherein in the second mode, the web page displays the translated text item in the second human language, but not the original text item in the first human language.

16. The method of claim 15, further comprising enabling a user to toggle between the first mode and the second mode.

17. The method of claim 15, wherein in the first mode, the original text item in the first human language is visible, and the translated text item in the second human language is hidden, and wherein in the second mode, the original text item in the second human language is hidden, and the translated text item in the first human language is visible.

18. The method of claim 13, further comprising identifying one or more other web pages that include the original text item, and enabling each of the one or more other web pages to be subsequently downloaded by one or more other users, with the translated text item being included with each of the one or more other web pages to supplement or replace the original text item on that page.

19. A system for providing content in multiple human languages, the system comprising:
a memory that stores a set of instructions;
one or more processors that use instructions in the set of instructions to provide:
a presentation component to provide a web page, the web page including a text content item that is provided in a first human language and in a second human language;
wherein the presentation component provides the web page in (i) a first mode in which the text content item is viewable in the first human language and hidden in the second human language, and (ii) a second mode in which the text content item is viewable in the second human language and hidden in the first human language.

20. The system of claim 19, wherein the presentation component enables a user to toggle between the first mode and the second mode without reloading the web page.

21. The system of claim 19, wherein the presentation component provides an interface for a user to specify a translation for any given text content item provided as part of the web page.

22. The system of claim 21, further comprising a component that identifies resources for one or more other web pages that include the given text content item that is specified by the translation, and associates the translation in the resources so that the translation is provided with each of the one or more other web pages that include the given text content item.
